(19) United States
(12) Patent Application Publication
(10) Pub. No.: US 2010/0323158 A1
(43) Pub. Date: Dec. 23, 2010

(54) ANTI NEWTON-RING AND ANTI-HIGHLIGHT STRUCTURE FOR STACKING TRANSPARENT PLATES

(76) Inventor: Teh-Zheng Lin, Taoyuan (TW)

Correspondence Address: Teh-Zheng Lin, 235 Chung - Ho Box 8-24, Taipei, TW

(21) Appl. No.: 12/486,741

(22) Filed: Jun. 17, 2009

(51) Int. Cl. B32B 3/00; B32B 17/06; B32B 27/36; B32B 27/30; B32B 9/04

(52) U.S. Cl. 428/141; 428/426; 428/412; 428/480; 428/522; 428/697

(57) ABSTRACT

An anti Newton-Ring and anti-highlight structure for stacking transparent plates which assembled by a plurality of transparent plates has at least a first anti Newton-Ring surface and a second anti Newton-Ring surface arranged about parallel. The above anti Newton-Ring surfaces are arranged without entirely attaching the front surface of the adjacent plate. The first anti Newton-Ring surface and the second anti Newton-Ring surface can be arranged respectively to an upper the lower surfaces of a same transparent plate. The surfaces also can be arranged to surfaces of two different transparent plates with similar or the same indexes of refraction and mechanical characteristics, and the surface roughnesses of the surfaces are between 0.1 μm to 35 μm. By the multiple anti Newton-Ring surfaces arranged to the stacking transparent plates, the Newton-Ring and the highlight interference can be eliminated and abated.

### FIELD OF THE INVENTION

The present invention relates to anti Newton-Ring and anti-highlight structure, and particular to that applied to a transparent touch panel or LCD assembled by stacking transparent plates so as to prevent the Newton-Ring and the interference of highlights.

### DESCRIPTION OF THE PRIOR ART

Common stacking transparent plate structures assembled by a plurality of stacking transparent plates such as resistive touch panel or LCD have an anti Newton-Ring layer within the stacking plates to prevent a light interference. The prior anti Newton-Ring structure is a plurality of protruding or concave regular or irregular pellets, wrinkles, or stripes arranged to a surface of a thin film layer so that the interference stripe will be distorted by the rough surface partially refracting or reflecting the light passing through the layer. But the protruding and concave structure will also condense or scatter the light so that highlights will appear on the surface. The highlights will cause distortion of the image especially to the high resolution screen or high brightness LCD.

### SUMMARY OF THE PRESENT INVENTION

Accordingly, the present invention provides an improved stacking transparent plate structure with anti Newton-Ring and highlight ability so as to prevent the light interference causing image problems.

The stacking transparent plates according to the present invention which assembled by a plurality of transparent plates has at least a first anti Newton-Ring surface and a second anti Newton-Ring surface arranged about parallel. The above anti Newton-Ring surfaces are arranged without entirely attaching the front surface of the adjacent plate. The Newton-Ring on the stacking transparent plates will be prevented by the first anti Newton-Ring surface and/or the second anti Newton-Ring surface. A highlights scattering effects is achieved by the complex effect of the first and the second anti Newton-Ring surfaces. The second anti Newton-Ring surface will refract or reflect the lights passing thought the first anti Newton-Ring surface so as to prevent highlights on the surface. The first anti Newton-Ring surface and the second anti Newton-Ring surface can be arranged respectively to an upper the lower surfaces of a same transparent plate. The anti Newton-Ring surfaces also can be arranged to surfaces of two different transparent plates with similar or the same index of refraction and mechanical characteristic, and the transparent material can be the Indium Tin Oxide (ITO), glass, polycarbonate (PC), polyester (PET), or the Polymethylmethacrylate (PMMA). The surface roughnesses of the anti Newton-Ring surfaces are between 0.1 μm to 35 μm.

The various objects and advantages of the present invention will be more readily understood from the following detailed description when read in conjunction with the appended drawing.

### BRIEF DESCRIPTION OF THE DRAWINGS

FIG. 1 is a cross section view showing an assembly of the present invention.

FIG. 2 is a cross section view of another embodiment of the present invention.

FIG. 3 is a cross section view of one another embodiment of the present invention, and

FIG. 4 is a cross section view of a yet embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention not to be used to confine the scope and spirit of the present invention defined in the appended claims.

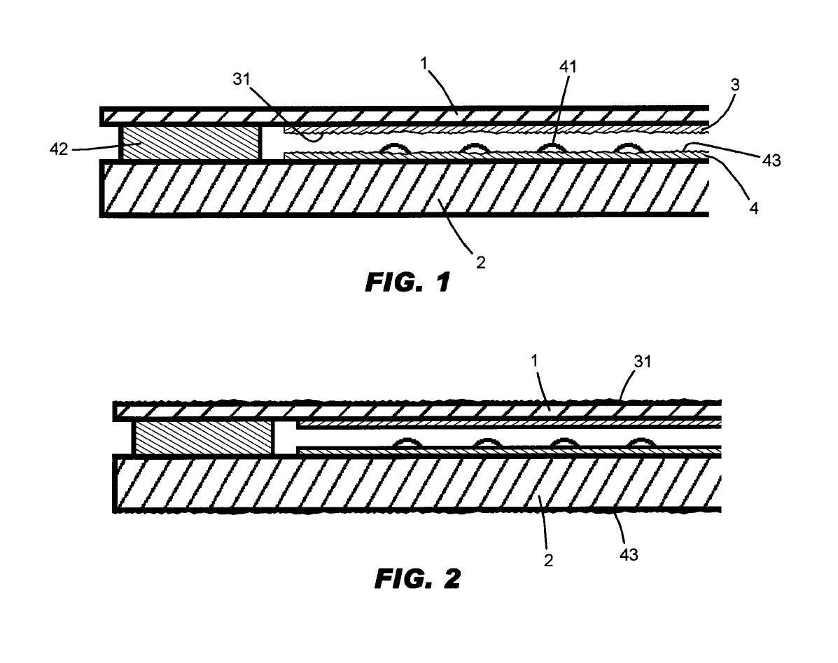

Referring to FIG. 1, an embodiment of the present invention applied to a resistive touch panel is illustrated. The resistive touch panel includes a touch sensing layer 1, substrate 2, upper conductive film 3, and a lower conductive film 4. The touch sensing layer 1 is a flexible high polymer thin film. The substrate 2 is a transparent glass plate. The upper and lower conductive films 3, 4 are transparent Indium Tin Oxide (ITO) thin film. The upper conductive film 3 is arranged to a bottom surface of the touch sensing layer 1, and the lower conductive film 4 is arranged to an upper surface of the substrate 2. A plurality of protruding spacers 41 are arranged between the upper and the lower conductive films 3, 4 so as to separate the two conductive films within an effective area. Normally, a gluing frame 42 is arranged outside the effective area of the two conductive films to glue the touch sensing layer 1 and the substrate 2 together so that the conductive films 3, 4 will be sealed inside the stacking plates. Moreover, a first anti Newton-Ring surface 31 is arranged to a bottom surface of the upper conductive film 3, and a second anti Newton-Ring surface 43 is arranged to an upper surface of the lower conductive film 4. The two anti Newton-Ring surfaces are facing to each other without touching, and the roughnesses (Ra) of the two surfaces are about 10 μm.

When the above touch panel is applied to a LCD (Liquid Crystal Display), the Newton-Ring will not be projected to the touch panel when the lights projected from the LCD pass through the second anti Newton-Ring surface 43 of the lower conductive film 4. The lights continuously passing through the first anti Newton-Ring surface 31 of the upper conductive film 3 will be refracted and/or scattered by the complex rough surface so that an interference of highlight on the touch panel will be eliminated. The two anti Newton-Ring surfaces will have augmenting effect to prevent the Newton-Ring. In the same condition of the anti Newton-Ring ability, each of the two anti Newton-Ring surfaces will have a relatively lower roughness than a structure having a single anti Newton-Ring surface so that a transparentness of the stacking plate will be improved. Moreover, the two anti Newton-Ring surfaces are arranged to materials of the same mechanical characteristic so that a collision or rubbing during operation will not cause serious damage.

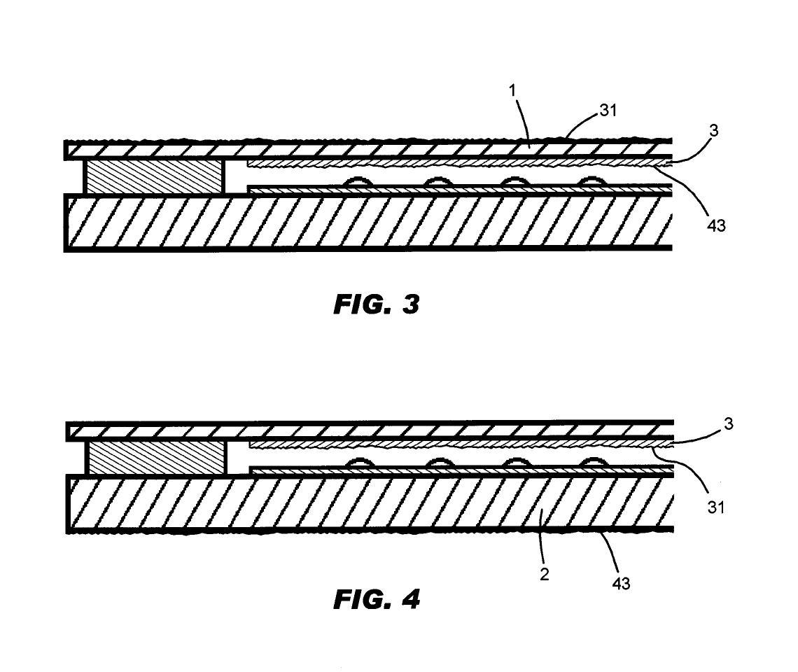

The embodiment is not used to confine the scope and spirit of the present invention. A lot of variations can be presented based on the above embodiment. For example, the first anti Newton-Ring surface 31 is arranged to an upper surface of the touch sensing layer 1, and the second anti Newton-Ring surface 43 is arrange to a bottom surface of the substrate 2 as shown in FIG. 2. Or, the first anti Newton-Ring surface 31 is arranged to the upper surface of the touch sensing layer 1, and the second anti Newton-Ring surface 43 is arranged to the bottom surface of the upper conductive film 3 as shown in FIG. 3. Further, the first anti Newton-Ring surface 31 can be arranged the bottom surface of the upper conductive film 3, and the second anti Newton-Ring surface 43 can be arranged to the bottom surface of the substrate 2 as shown in FIG. 4.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An anti Newton-Ring and anti-highlight structure for stacking transparent plates comprising at least a first anti Newton-Ring surface and a parallel second anti Newton-Ring surface in the stacking transparent plates; the above anti Newton-Ring surfaces being arranged without entirely attaching the front surface of the adjacent plate.

2. The anti Newton-Ring and anti-highlight structure for stacking transparent plates as claimed in claim 1, wherein the first anti Newton-Ring surface and the second anti Newton-Ring surface are arranged to surfaces of different transparent plates.

3. The anti Newton-Ring and anti-highlight structure for stacking transparent plates as claimed in claim 2, wherein the transparent plates having the first anti Newton-Ring surface and second anti Newton-Ring surface arranged thereon have similar or the same indexes of refraction.

4. The anti Newton-Ring and anti-highlight structure for stacking transparent plates as claimed in claim 3, wherein the transparent plates having the first anti Newton-Ring surface and second anti Newton-Ring surface arranged thereon are made of transparent materials of similar or the same mechanical characteristic.

5. The anti Newton-Ring and anti-highlight structure for stacking transparent plates as claimed in claim 4, wherein the transparent material is one of the Indium Tin Oxide (ITO), glass, polycarbonate (PC), polyester (PET), or the Polymethylmethacrylate (PMMA).

6. The anti Newton-Ring and anti-highlight structure for stacking transparent plates as claimed in claim 4, wherein the two anti Newton-Ring surfaces are being arranged without entirely attaching the front surface of the adjacent plate.

7. The anti Newton-Ring and anti-highlight structure for stacking transparent plates as claimed in claim 1, wherein the two anti Newton-Ring surfaces are arranged respectively to an upper and lower surfaces of the same transparent layer.

8. The anti Newton-Ring and anti-highlight structure for stacking transparent plates as claimed in claim 1, wherein the roughnesses (Ra) of the two anti Newton-Ring surfaces are between 0.1 μm to 35 μm.
